(19) United States
(12) Patent Application Publication
(10) Pub. No.: US 2025/0340262 A1
(43) Pub. Date: Nov. 6, 2025

(54) MOBILE ASSEMBLY LINE AND ASSOCIATED METHOD, PARTICULARLY FOR THE ASSEMBLY OF VEHICLES

(71) Applicant: CPM S.P.A., TORINO (IT)

(72) Inventors: Massimo BELLEZZA, TORINO (IT); Denny MONTI, TORINO (IT)

(73) Assignee: CPM S.P.A., TORINO (IT)

(21) Appl. No.: 18/871,984

(22) PCT Filed: Jun. 5, 2023
(86) PCT No.: PCT/IB2023/055763

§ 371 Date: Dec. 5, 2024

(30) Foreign Application Priority Data
Jun. 7, 2022 (IT) 102022000012020
Oct. 24, 2022 (DE) 10 2022 128 024.1

(51) Int. Cl. B62D 65/18

(52) U.S. Cl. CPC B62D 65/18

(57) ABSTRACT

A plant and method for the assembly of vehicles wherein a motorized module associated with a plurality of other modules similar or identical but independent of them is moved along a predetermined trajectory, in a coordinated manner with the other modules, to cause the module assume a plurality of different positions in each of which the same module comes to constitute sequentially a different assembly station of the assembly plant, which is thus totally movable and reconfigurable.

### CROSS-REFERENCE TO RELATED APPLICATIONS

This Patent Application claims priority from Italian Patent Application No. 102022000012020 filed on Jun. 7, 2022, and from German Patent Application No. 10 2022 128 024.1 filed on Oct. 24, 2022, the entire disclosure of which is incorporated herein by reference.

### TECHNICAL FIELD OF THE INVENTION

The present invention relates to an assembly plant and to an associated method for carrying out the assembly of vehicles, particularly motor vehicles, configured to create a movable and reconfigurable assembly line.

### PRIOR ART

It is known that vehicles are nowadays assembled in series by means of fixed plants forming assembly lines or chains including a series of fixed processing stations and ground or overhead conveyor devices that serve the processing stations to feed them with the mechanical parts to be assembled, and/or cross the processing stations to transport along the assembly line the vehicle bodies that must receive the mechanical parts. At the end of the assembly line, fully assembled vehicles are released/picked up/abandoned from the conveyor device and placed in storage.

Here and below, by the term “mechanical parts” is to be meant all the elements that must be obtained and/or assembled individually and then mounted on the body, such as the side doors, the motor (thermal or electric), the transmission components (gearbox, axles, etc.), batteries, the dashboard, the front and rear suspensions with their components, such as shock absorbers, springs, etc.

The assembly plants of the type described above, and currently in use, present numerous drawbacks.

Firstly, since they are fixed structures and designed for a fixed maximum number of vehicles to be produced, they are not at all flexible, while the market, especially the automotive one, has become relatively volatile in the number and type of vehicles requested. Consequently, in the event of a request for a higher number of vehicles than the project number, a new plant must be built, with unacceptable waiting times. In the case, more frequently, of a request for a lower number of vehicles than the project number, the plant is oversized and the production costs increase accordingly.

These drawbacks are more present in the case of assembly plants envisaged for new vehicle models to be launched on the market, whose production volumes are uncertain.

Secondly, the plants or assembly lines in use today require considerable investments at structural level, as it is necessary to provide for the construction of buildings, support structures and pits for the conveyors and the assembly stations, etc.

Thirdly, once one has chosen a specific layout for the plant, it is not possible to modify it in case of changed needs, except by temporarily stopping the plant itself and in any case with considerable investment costs and, usually, technical difficulties to be overcome in order to make the necessary changes.

Finally, in the case of changed production needs that involve a relocation of the plant, it is necessary to provide for new support structures (buildings, pits, supporting structures) and then for the disassembly and reassembly of the conveyor devices and of the assembly stations.

### SUMMARY OF THE INVENTION

Aim of the present invention is therefore to provide an assembly plant and an associated method for carrying out the assembly of vehicles, particularly motor vehicles, which are free from the drawbacks of the above-identified state of the art. It is in particular an aim of the invention to provide an assembly plant configured to create a reconfigurable and easily movable assembly line.

It is also an aim of the invention to provide a module for realizing a method and an assembly plant that are at the same time extremely flexible in terms of production volumes and, at the same time, economically sustainable, so as to be able to easily manage changes in production volumes and/or vehicle model.

Based on the invention, there are therefore provided a plant and a method for carrying out the assembly of vehicles, particularly motor vehicles, as well as an associated motorized module, as defined in the appended claims.

### BRIEF DESCRIPTION OF THE DRAWINGS

Further features and advantages of the present invention will become apparent from the following description with reference to the accompanying drawings, which show non-limiting embodiments thereof, and wherein:

FIG. 1 schematically shows a three-quarter perspective view from above of a module constituting an essential element of the assembly plant of the invention;

FIGS. 2 and 3 show schematically and on an enlarged scale respective orthogonal views in elevation, side and rear, of the module of FIG. 1, in two respective different configurations thereof;

FIGS. 4a and 4b show schematically and on an enlarged scale respective orthogonal views in elevation, side and rear, of the module of FIG. 1, in a first possible working configuration thereof;

FIGS. 5a and 5b show schematically and on an enlarged scale respective orthogonal views in elevation, side and rear, of the module of FIG. 1, in a second possible working configuration thereof;

FIG. 6 schematically shows a three-quarter perspective view from above of the assembly plant of the invention (or part thereof), comprising a plurality of modules identical to that of FIG. 1;

FIG. 7 schematically shows, both in plan and in elevation, the assembly plant of the invention or part thereof, during the simultaneous execution of a plurality of different assembly steps, carried out sequentially on the same vehicle body as it advances in the direction of the upward arrow, together with a module like the one of FIG. 1 on which the body is transported;

FIGS. 8 and 9 show schematically and on an enlarged scale the same perspective view of a module as that of FIG. 1 but equipped with different possible additional equipment;

FIGS. 10 and 11 schematically show two different layouts obtainable with the assembly plant of FIG. 6 simply by reconfiguring the relative position of a plurality of modules like the one of FIG. 1;

FIG. 12 shows schematically and for purely exemplary purposes a module equipped like the one of FIG. 8 during the execution of respective different assembly steps, schematically indicated by the arrows;

FIG. 13 schematically shows on an enlarged scale a perspective view of a preferred embodiment of a movement device for the module of FIG. 1;

FIG. 14 schematically shows on a reduced scale a perspective view of a detail of a preferred embodiment of the module of FIG. 1, wherein the movement device of FIG. 13 is equipped with a protection screen;

FIG. 15 schematically shows on an enlarged scale a three-quarter perspective view from above of a portion of the module of FIG. 1;

FIG. 16 shows schematically and on a reduced scale part of the same view of FIGS. 15, wherein the module of FIG. 1 is provided with a preferred additional element;

FIG. 17 schematically shows, on a greatly enlarged scale, a highly preferred constructional detail of the module of FIG. 1;

FIG. 18 shows schematically and on an enlarged scale a front elevation view of a preferred embodiment of a power supply system of, and/or for sending control signals to, the module of FIG. 1; and

FIG. 19 shows schematically and on a greatly enlarged scale a side elevation view of the power supply and/or control system of FIG. 18.

### DETAILED DESCRIPTION

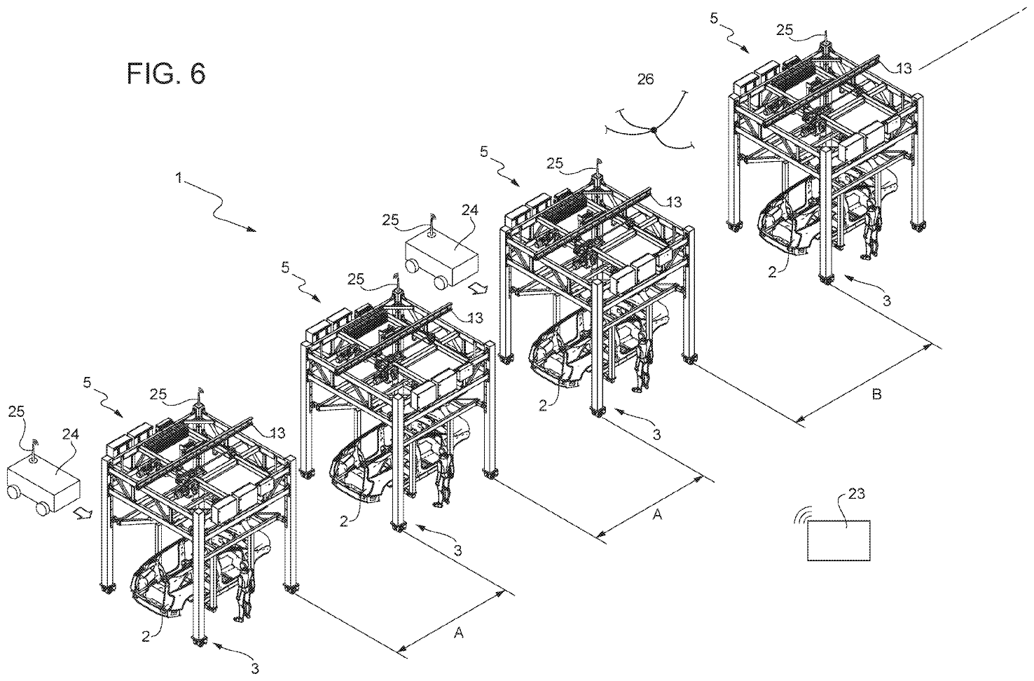

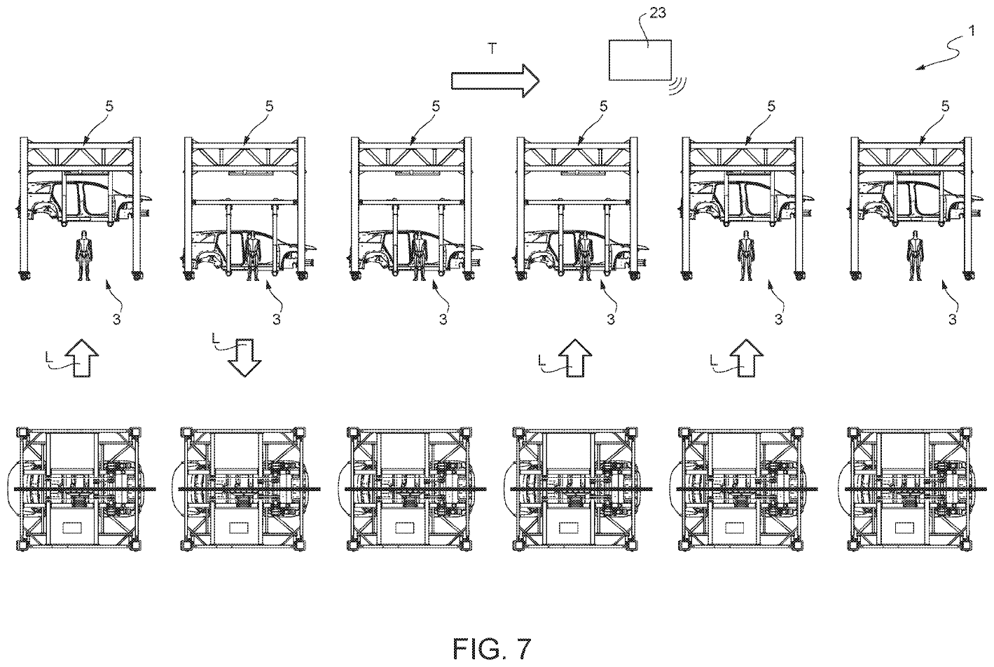

With reference to FIGS. 6 and 7, the reference numeral 1 denotes, as a whole, an assembly plant (FIG. 6) for vehicles, particularly motor vehicles, which are known and of which only one body 2 is schematically shown.

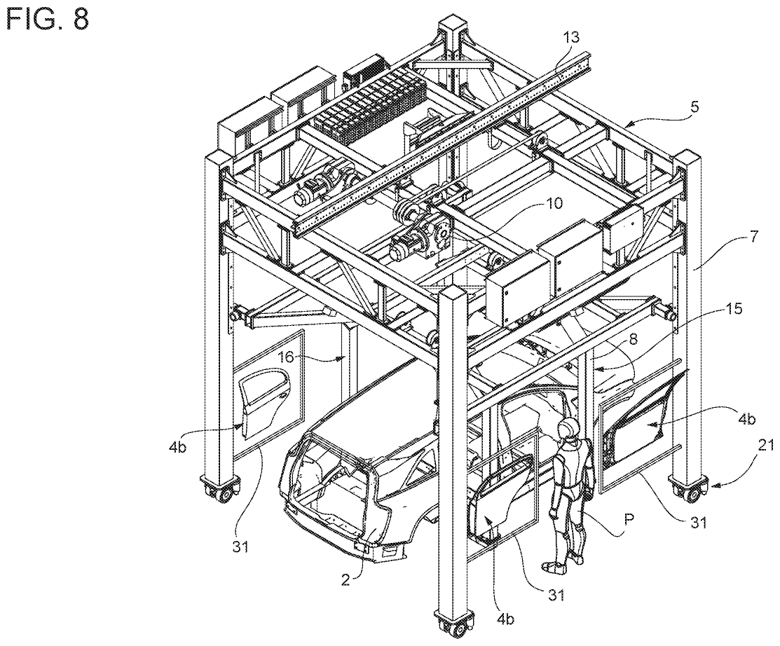

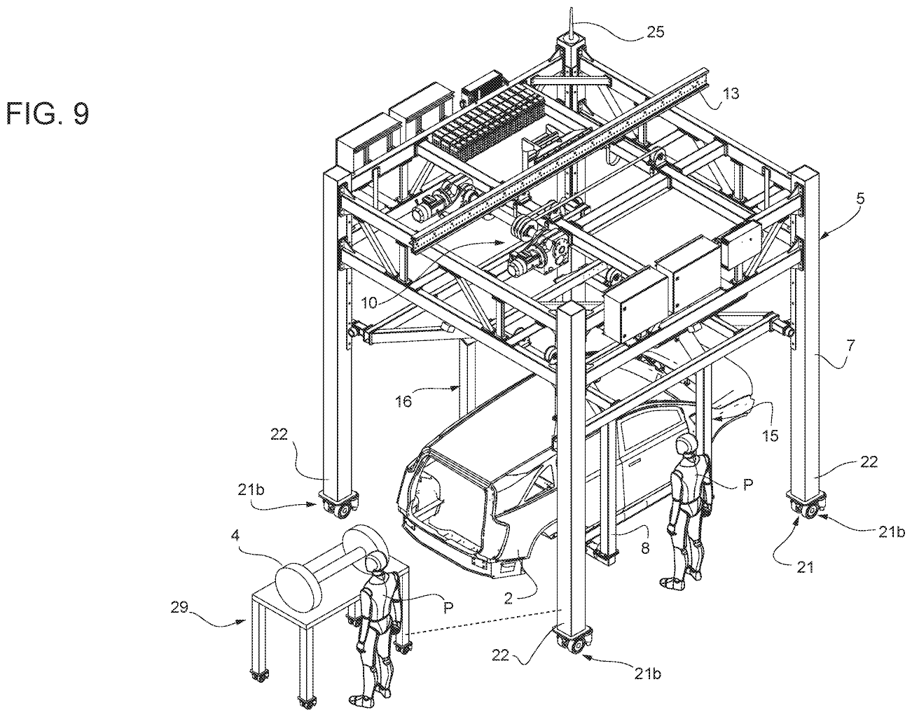

The plant 1 (FIGS. 6 and 7) is configured to carry out the assembly of vehicles, particularly motor vehicles, and comprises a plurality of assembly stations 3 configured to receive respective vehicle bodies 2 and respective mechanical parts 4 (FIG. 9) to be assembled on the bodies 2; in FIG. 9 the mechanical part 4 is shown in a schematic way and without any claim of likelihood: the mechanical parts 4 can be constituted by any element that must be obtained and/or assembled individually and then mounted on the body 2, such as the side doors (which in FIGS. 8 and 12 are explicitly shown, albeit schematically, and denoted with the reference number 4b), the motor (thermal or electric), the transmission components (gearbox, axles, etc.), batteries, the dashboard, the front and rear suspensions with their components, such as shock absorbers, springs, seats and other internal elements, etc.

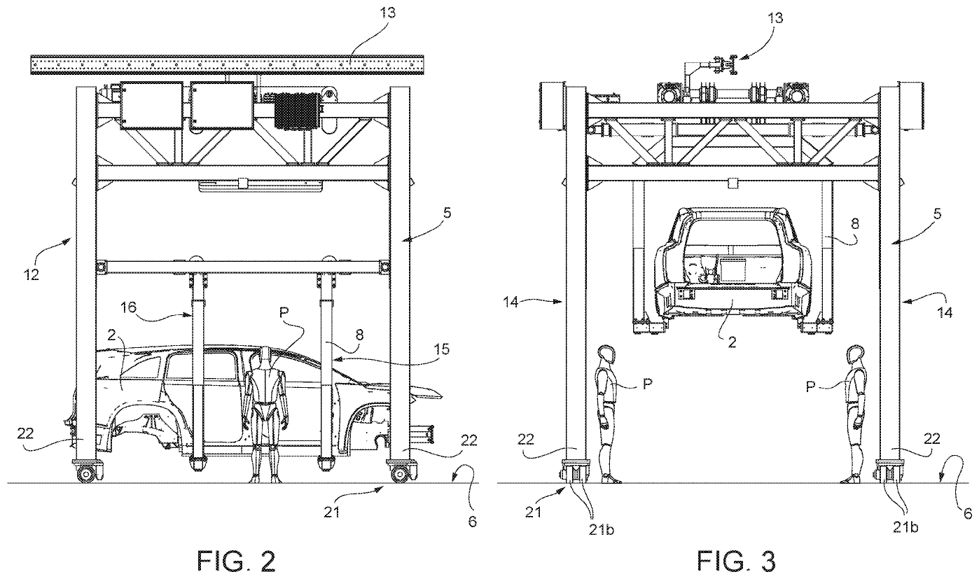

According to the main feature of the invention, the plant 1 comprises, in combination with each other, a plurality of mutually independent and substantially identical or at least similar motorized modules 5, in the sense that they have the same basic structure, and that they are configured to be movable, in the manner that will be seen, on a floor or support plane 6 (FIGS. 2-5).

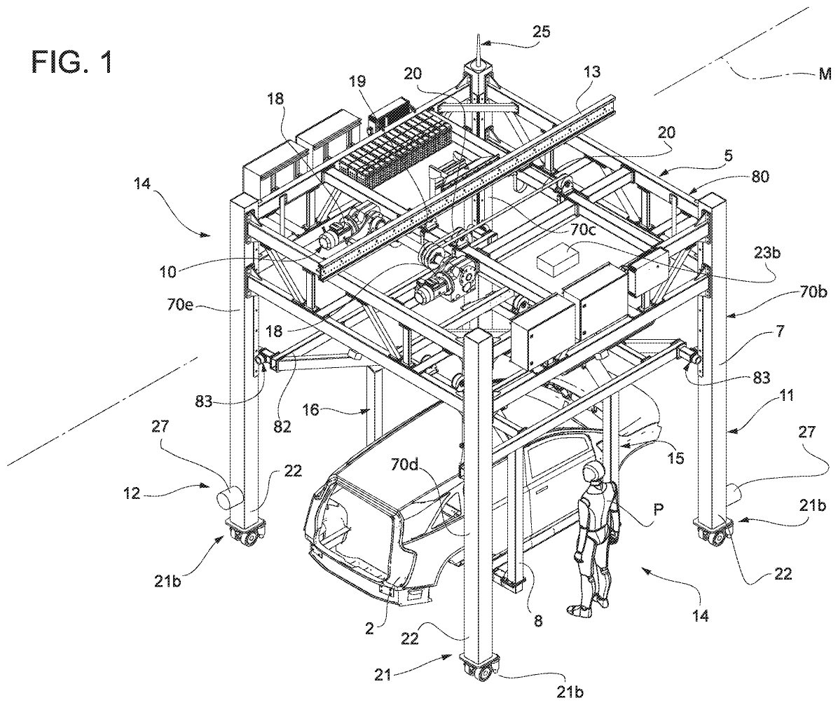

The basic structure of each module 5 can be inferred from FIGS. 1 to 5 and from 8 to 9, wherein in each of these figures a module 5 is schematically shown, optionally provided with different equipment.

With reference to such figures, each module 5 comprises a three-dimensional supporting structure 7 equipped with a hook unit 8 of any known type, configured to receive a vehicle body 2 and to hold the body 2 in a removable and per se known manner, constrained integral with the respective module 5. For example, the hook unit 8 can be of the same type as those commonly used in the overhead conveyor devices, where trolleys run on suspended rails and carry inferiorly a hook unit of the type of the hook unit 8, to which a body 2 is hooked.

The ways of constraining and releasing the body 2 from the respective hook unit 8 are known and are therefore not shown for simplicity's sake, for example the hook units 8 are equipped with rotatable pins with hammer head and loaded by springs, whose heads can be inserted and locked in special slots of the body 2.

Each module 5 further comprises a first motorized system 10 mounted on the supporting structure 7 and configured to at least raise and lower on command the hook unit 8. The motorized system 10 may comprise, as will be seen, one or more motors/actuators.

Going more into detail, the supporting structure 7 is made of metallic steelwork by means of a plurality of beams (uprights and side members) connected to each other bolted or welded, whereby it is constituted by a reticular structure with high rigidity and substantially parallelepiped shape (but could have any shape, depending on specific bulky and/or process requirements), which has a front end 11 and an opposite rear end 12 (FIG. 1) crossed above along a centreline (axis M in FIG. 1) of the supporting structure 7 by a double T-beam 13, which can also be configured to be used as an electrical power supply rail, as will be seen. The beam or rail 13 is not part of the module 5, but is a static part (with respect to the plurality of modules 5) of the plant 1. The rail 13 can be made in a reconfigurable manner.

Parallel to the beam or rail 13 and therefore transversely to the ends 11 and 12, the supporting structure 7 is delimited by two opposite open flanks 14 (FIG. 1). Also, the ends 11 and 12 are open, so that, in use, respective operators P (of whom the outlines are shown in the attached Figures, also to account for the relative proportions) can access the body 2 from all sides, “entering” inside the supporting structure 7.

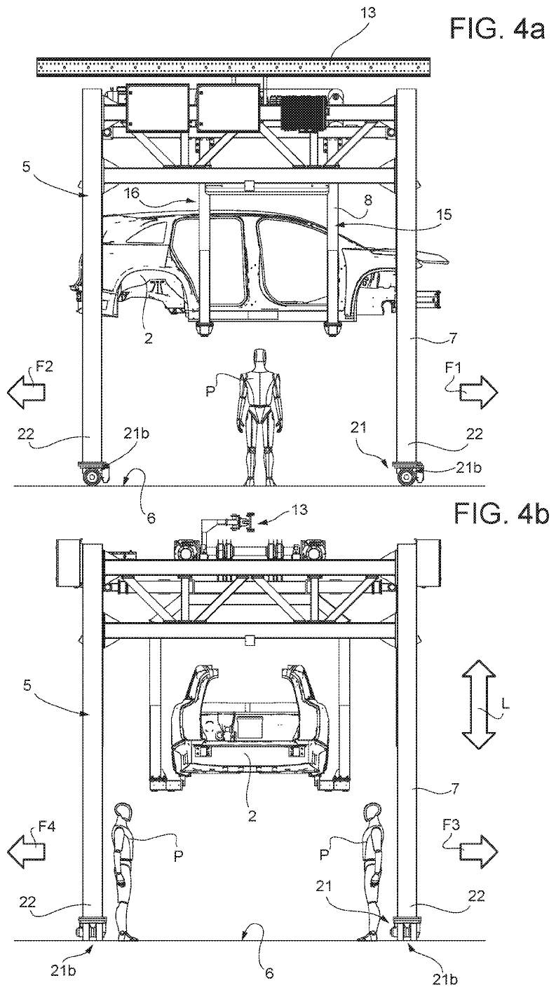

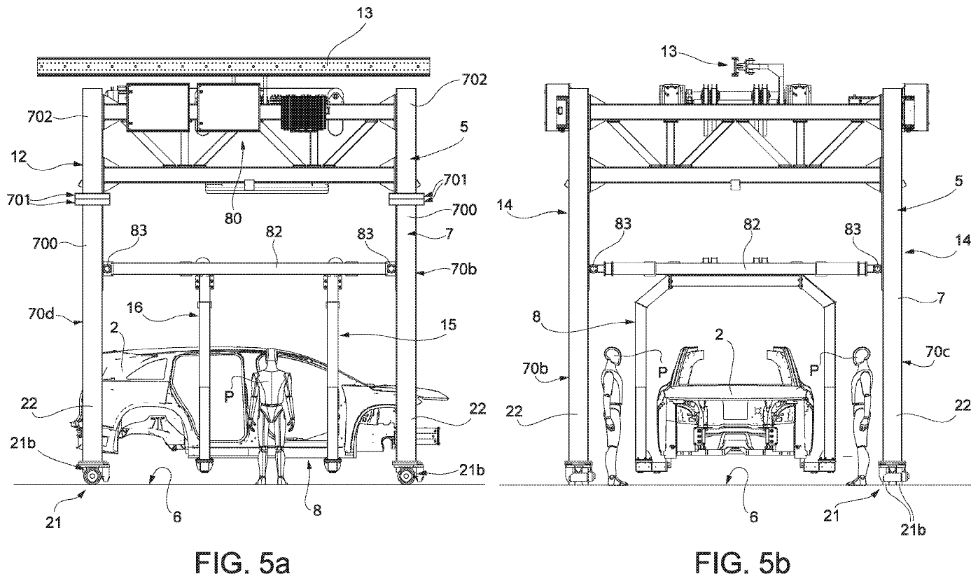

The first motorized system 10 (FIG. 1) is configured not only to raise and lower on command the hook unit 14 in the direction of the arrows L (FIGS. 4b and 7), so as to cause them assume in use at least two opposite operating positions (high and low) well shown in FIGS. 4 and 5, in which the body 2 is in any case substantially parallel to the floor 6, but also, if necessary, to make the hook unit 8 tilt, and with it the body 2 carried by it, toward the front 11 or rear 12 end of the supporting structure 7 by raising and/or lowering a corresponding end 15 and, respectively 16, of the hook unit 8, the body 2 being arranged with its front part facing the part of the end 15 and with its rear side facing the part of the end 16.

Furthermore, the first motorized system 10 can also preferably be configured to rotate the hook unit 8 transversely to the front and rear ends 11, 12 of the supporting structure 7 (i.e. in a plane parallel to respective planes passing therethrough and perpendicular to the flanks 14), so as to make the upper (roof) or lower (floor) parts of the body 2 show up on command, in use and towards any of the flanks 14.

For this purpose (FIG. 1) the first motorized system 10 may comprise at least a pair of electric motors (or other type of actuator) 18 and a plurality of return pulleys (or toothed wheels) 19 and of belts or transmission chains 20 connected on one side to the electric motors 18 and on the other side to the ends 15 and 16 of the hook unit 8, for example on both opposite flanks thereof. Obviously, any other type of motorization and of transmission/actuation, obvious to the skilled person on the basis of the above, is possible.

According to an important aspect of the invention, each module 5 also comprises at least a second motorized system 21 mounted on the supporting structure 7 and configured to move horizontally, i.e., parallel to the floor 6 and on/along the floor 6 itself each respective module 5.

The floor 6 is in fact configured to receive all the modules 5 resting thereon, which are configured to move in the way that will be seen on the floor 6 under the action of the second motorized system 21, so that the floor 6 defines a ground plane of the plant 1. Obviously, the floor 6 can be horizontal or even slightly tilted.

In particular, the second motorized system 21 is configured to advance and/or retreat on the floor 6 each corresponding module 5 on the side of the front 11 or rear 12 end portion of the supporting structure 7 thereof, in the direction of the arrows F1 and F2 (FIG. 4a).

For this purpose, the supporting structure 7 is provided with respective feet 22 equipped with motorized wheels 21b, preferably actuatable independently of each other, and with reversible rotation.

Preferably, the second motorized system 21 is also configured to make the respective module 7 move laterally, transversely to the ideal centreline M connecting the front end 11 and the rear end 12 of the supporting structure 7 with each other, in the direction of the arrows F3 and F4 (FIG. 4b).

For this purpose, the motorized wheels 21 can be steering or, more simply, the wheels 21b present on the opposite sides 14 can be rotated in the opposite direction, or even more it can be provided for motorized wheels 21b oriented perpendicularly to each other for each foot 22.

According to one aspect of the invention, the plant 1 also comprises a (electronic) control system, denoted as a whole with 23 and schematically shown in FIGS. 6 and 7 as a block.

The control system 23, preferably of programmable type, is configured to move each module 5 belonging to the plant 1 on the floor 6 along a predetermined trajectory T (FIG. 7) in a coordinated manner with the other modules 5 belonging to the same assembly plant 1. In particular, the control system 23 is configured to define by means of the modules 5 all the assembly stations 3 necessary for said plant 1.

In particular, the control system 23 is configured to move the modules 5 on the floor 6 sequentially, one behind the other but spaced apart to each other (FIGS. 6 and 7), arranged in a row line following in plan the trajectory T, that can be rectilinear and/or curvilinear and/or serpentine-like. The rail 13 can be configured by time to time, obviously for the skilled person, so as to follow the trajectory T.

The control system 23 is also configured to maintain between the modules 5 (FIG. 6) a constant pitch (step A) or a variable pitch (passing for example from step A to a step B and vice versa), depending on the production requirements.

The modules 5 can be moved by the control system 23 in a continuous (with speed also variable from module 5 to module 5) or discrete manner, that is by successive steps, for example interspersed with stops of predetermined, constant or variable duration, which stops can correspond to the moment in which each module 5 comes to constitute a specific assembly station 3 of the plant 1.

In order to be able to feed the mechanical parts 4 to the assembly stations 3 constituted by time to time by a module 5 that is located in a specific spatial position on the floor 6, the assembly plant 1 according to the invention finally comprises a plurality of motorized trolleys 24 that are self-guided and configured to transport the necessary mechanical parts 4, separately or one or more per trolley 24, to predetermined modules 5.

In particular, the trolleys 24 can be configured to go and flank a predetermined module 5 while it is moving, assuming the same speed thereof; or they can be configured to go and flank a predetermined module 5 while it has been parked by the control system 23 in a predetermined position on the floor 6.

How to implement the control system 23 in practice and how to supply power to the motorized systems 10 and 21 is a routine operation, but a highly preferred and advantageous embodiment will be described later.

For example, as pictorially schematized in FIGS. 6 and 7, the control system 23 can consist of a centralized fixed station equipped with an electronic processing system and with a wifi network through which it controls the position and movement of the modules 5 by suitably actuating the motorized wheels 21b and the position of the hook unit 8 (high, low, tilted, rotated) by suitably driving the motors 18 of the motorized system 10.

Or the block 23 in FIG. 6 can represent a simple tablet operated by an operator P who gives the necessary instructions, in which case on board each module 5 it will be provided a processing unit, in other words a control system 23b (FIG. 1) dedicated, for each module 5, to actuate the motorized systems 10 and 21.

In both cases, each module 5 can be provided with an antenna 25 for receiving the wifi signal and with this the commands sent by the control system 23. According to this possible embodiment, also the motorized trolleys 24 are provided with antennas 25, so that they too can be commanded in their movements by the control system 23.

Similarly, to actuate the motorized wheels 21b and the motors 18, it can be provided an overhead power supply network 26 (FIG. 6), for example of the type of those used by the trams, which powers the rails 13.

Alternatively, the supporting structure 7 may be provided with rechargeable batteries, so that each module 5 is completely independent of any fixed structure. For the same reason, each module 5 can be provided with its own control system 23b (FIG. 1) having a memory and programmable, so that each module 5 comes to constitute a self-driving vehicle that moves based on the program stored in the electronic system 23b. Or, again, the control system can be divided in part as fixed station or tablet 23 and as programmable units 23b on board the modules 5.

The motorized trolleys 24 may be driven and commanded in a manner similar to that described for the modules 5.

Especially in the case of fully autonomous modules 5, each module 5 may comprise a plurality of sensors 27 (FIG. 1), for example radar, such as LIDAR sensors, carried by each supporting structure 7, for example at the ends 11 and 12, configured to provide the control system 23 (and/or 23b) with the position and distance of at least one possible module 5 preceding and one possible module 5 following each module 7 along the trajectory T (FIGS. 6 and 7).

Therefore, the control system 23 can be at least partly on board each module 5 (control system 23b), constrained to the supporting structure 7, and is programmable, so that each supporting structure 7 of each module 5 constitutes a programmable self-driving vehicle, or the control system 23 is at least partly positioned stationary with respect to the floor 6 or is carried by one or more operators P consisting of a series of suitably programmed tablets, and communicates by means of a data transmission system, preferably of the wifi type, with the modules 5. On the other hand, in the presence of an overhead power supply electrical network 26, this could also be configured to transmit command signals through the rail 13.

Alternatively, power supply and control signals could for example be transmitted through suitable tracks (known and not shown) positioned in the floor 6 according to the desired trajectory T (or a number of possible alternative trajectories). The same applies for the rail 13.

With specific reference to FIGS. 8, 9 and 12, each module 5, or only one or a part of the modules 5 belonging to the assembly plant 1 according to the invention, can be equipped with a series of additional equipment.

For example, according to what is shown in FIG. 9, with a module 5 it can be associated a trailer 29, for example mechanically hooked to the module 5 by means of tie rods 30, or the trailer 29 is configured as a self-driving element equipped with a thethering function, that is programmed to follow the module 5 without a mechanical connection between the two but as if it existed. On the trailer 29 it can be arranged a mechanical part 4 to be mounted on the body 2, already finished, or which is to be assembled by operators P along the path of the module 5, for example in this case the mechanical part 4 could be a vehicle dashboard, which once finished is picked up by one or more operators P and mounted on the body 2 “entering” the supporting structure 7 through one of its open sides 14 or its open ends 11, 12.

According to what is shown in FIGS. 8 and 12, instead, one or more modules 5 can be equipped with supports 31

(FIG. 8) for example fixed integral with the supporting structure 7 on the open flanks 14 and to such supports 31 mechanical parts constituted for example by the framework of the doors 4b of the vehicle to be obtained can be hung. The doors 4b can therefore be completely assembled with the addition of other mechanical parts (window lifters, glasses, finishing panels), carried by trolleys 24, by operators P along the path of the module 5, and then mounted on the body 2 (FIG. 12) thanks to the total accessibility from four sides allowed by the supporting structure 7.

Based on what has been described so far, it is evident that the invention is also related to a method for carrying out the assembly of vehicles, particularly motor vehicles, comprising the step of moving a respective body 2 of vehicle through a plurality of assembly stations 3 to which are also fed respective mechanical parts 4 to be assembled on the bodies 2 and which, according to the invention, comprises the steps of:
i)—making a plurality of independently movable modules 5, each of which comprises: a three-dimensional supporting structure 7 equipped with a hook unit 8 configured to receive a vehicle body 2 and to hold the body 2 constrained integral with the respective module 5; a first motorized system 10 mounted on the supporting structure 7 and configured to at least raise and lower on command the hook unit 8; and a second motorized system 21 mounted on the supporting structure 7 and configured to horizontally move each respective module 5;
ii)—moving each module 5, with a body 2 coupled to the hook unit 8, along a predetermined trajectory T and in a coordinated manner with the other modules 5, so that each module 5 reaches sequentially a plurality of predetermined positions along the trajectory T (FIG. 7), a same module 5 coming therefore to constitute, sequentially, each of the assembly stations 3.

The method of the invention further comprises the step of:
iii)—feeding the mechanical parts 4 to the assembly stations 3 by having each module 5 sequentially flanked by a self-guided trolley 24 on which the mechanical parts 4 to be assembled have been loaded; and/or hook onto the supporting structure 7 of each module 5 at least some of the mechanical parts to be assembled.

Finally, it is evident that the invention also extends to a motorized module such as the module 5 of FIG. 1, which can be associated with a plurality of other similar or identical motorized modules 5, like in FIG. 6, to create a plant 1 for the assembly of vehicles, particularly motor vehicles, which is totally movable and reconfigurable, wherein the module 5 of the invention comprises:
a) a three-dimensional supporting structure 7 equipped with a hook unit 8 configured to receive a vehicle body 2 and to hold the body 2 constrained integral with said module 5;
b) a first motorized system 10 mounted on the supporting structure 7 and configured to at least raise and lower on command said hook unit 8 and, preferably, to tilt and/or rotate it;
c) a second motorized system 21 mounted on the supporting structure 7 and configured to move the module 5 horizontally on a support plane 6, such as a floor;
d) a control system 23b carried on board by the supporting structure 7 to move the module 5 along a predetermined trajectory, in a coordinated manner with other modules 5 similar or identical thereto, the control system 23b being configured to cause the module 5 on which it is mounted to assume and along a predetermined trajectory T, a plurality of different positions in each of which the same module 5 comes to constitute sequentially, by time to time, a different assembly station 3 of a plurality of assembly stations 3 of the assembly plant 1 for which the module 5 is configured; and
e) a possible data reception system (e.g. antenna 25) for receiving wifi signals from a ground control system (manual or automatic), for example represented by a simple tablet served by an operator P.

With reference to FIG. 7, therein it is pictorially represented the plurality of positions and of configurations that each module 5 can assume while moving along the trajectory T queueing other modules 5, to form a “train” of modules 5 moving in unison and with the hook units 8 moving in the direction of the arrows L depending on the position of the single module 5.

Therefore, according to the invention, instead of advancing a body 2 through a plurality of fixed assembly stations 3 arranged along the trajectory T, the stations themselves are advanced, constituted according to the invention not by fixed installations but by movable modules 5, along a same trajectory T, each module 5 coming by time to time to assume the function of a specific assembly station 3 depending on the position reached along the trajectory T.

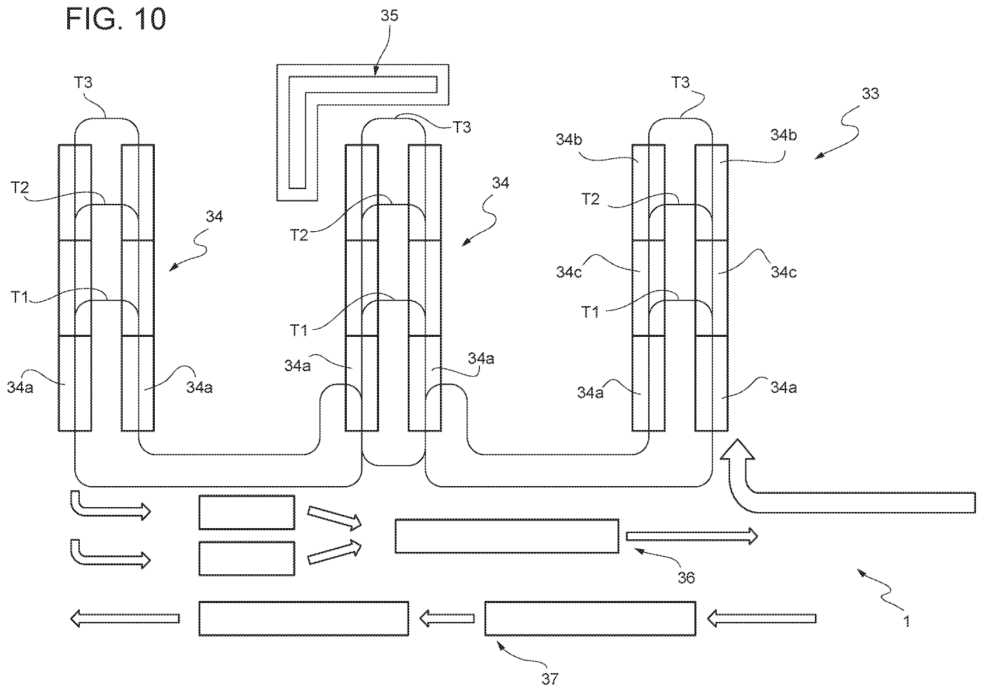

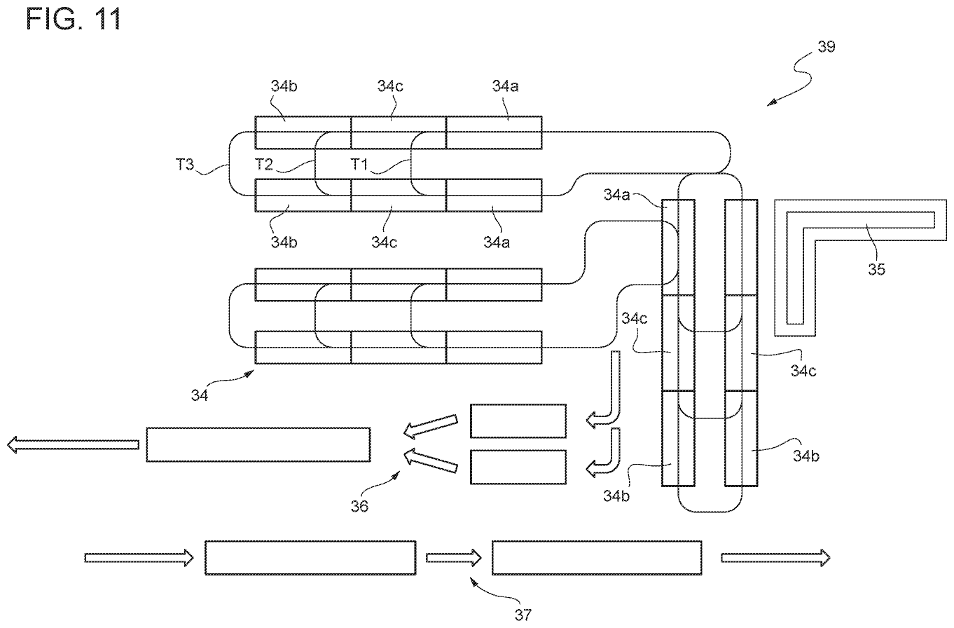

Thanks to this revolutionary concept it is possible to modify at any time both the layout and the production capacity of a plant 1 created according to the invention, as schematically represented in FIGS. 10 and 11, simply by varying the number of modules 5 to be used and their movement trajectory.

In the case of new installations, it will be possible to create an assembly line 33 having the layout shown in FIG. 10 using more blocks 34 of units 5 arranged to advance lined up like in FIG. 7. For example, it will be possible to set up three parallel lines of blocks 34a of moving modules 5 that follow the trajectory T1. In the case of increased production capacity, it will be sufficient to add other blocks 34c and 34b of modules 5 sequentially to the blocks 34a, so that the modules 5 follow the (progressively wider) trajectories T2 and T3.

According to FIG. 10, a plant 1 according to the invention therefore forms an assembly line 33 which is completed by a sub-assembly line 35, for example fixed or in any case of known type, for assembling complex mechanical parts 4 (e.g. motor), by a test line 36 and by a shipping line 37.

In this case the only necessary fixed installation is the floor 6, the entire plant 1 being able to be set up even outdoors, for example under tensile structures, or in existing buildings, independently of the plan configuration of the same.

In the case of replacement of pre-existing production lines, for which there is already a specially prepared building, it will be possible to create an assembly line 39 having the layout shown in FIG. 11 using also in this case several lines of blocks 34 of modules 5, with the same advantage of being able to vary the production capacity simply by using or not all blocks 34b, 34c and 34a or only the blocks 34a. Also in this case, the assembly line 39 is completed by a sub-assembly line 35, for example fixed or in any case of known type, for assembling complex mechanical parts 4 (for example motor), by a test line 36 and by a shipping line 37.

The difference between the lines 33 and 39 is that while in the line 33 all the blocks 34 can be arranged in parallel and perpendicular to the test and shipping lines, with optimal use of the spaces, in the line 39 some blocks 34 must be forcibly arranged perpendicular to each other, but this does not represent a problem, on the contrary also in this case an optimal use of the already existing spaces is achieved.

Finally, in case of relocation of the plant 1, it will be necessary to simply pack and ship the modules 5 that belong thereto, since it is not necessary to disassemble or specifically create support structures to allow creating with the plant 1 a desired assembly line, for example one of the lines 33 or 39.

In order to ensure that a plant 1 like the one described so far is operationally reliable and can be created in a sustainable manner, however, it has been found that it is important to select appropriate embodiments of specific construction details thereof.

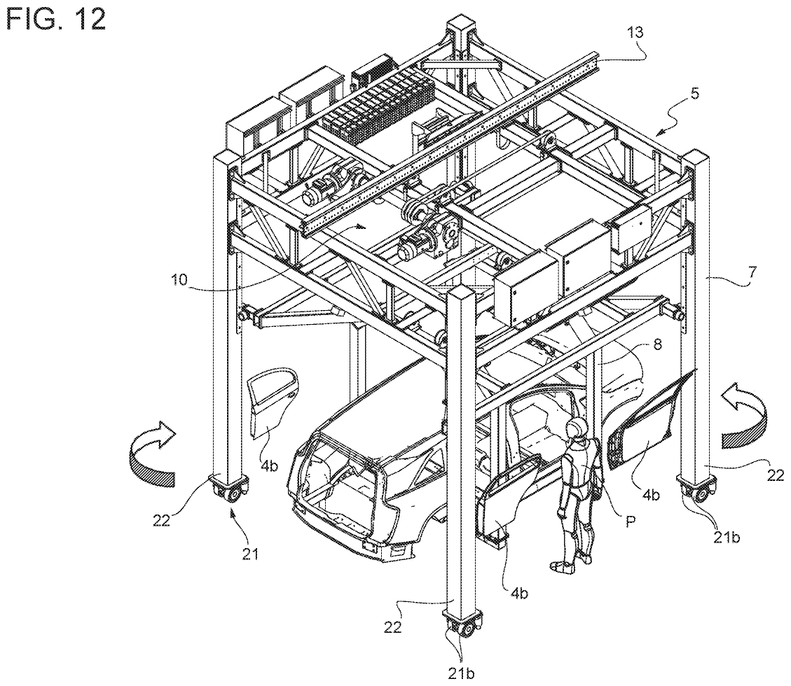

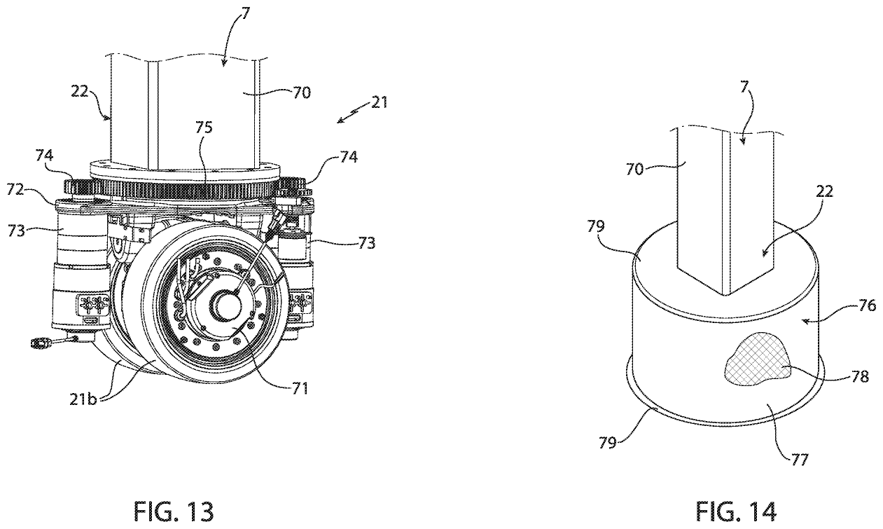

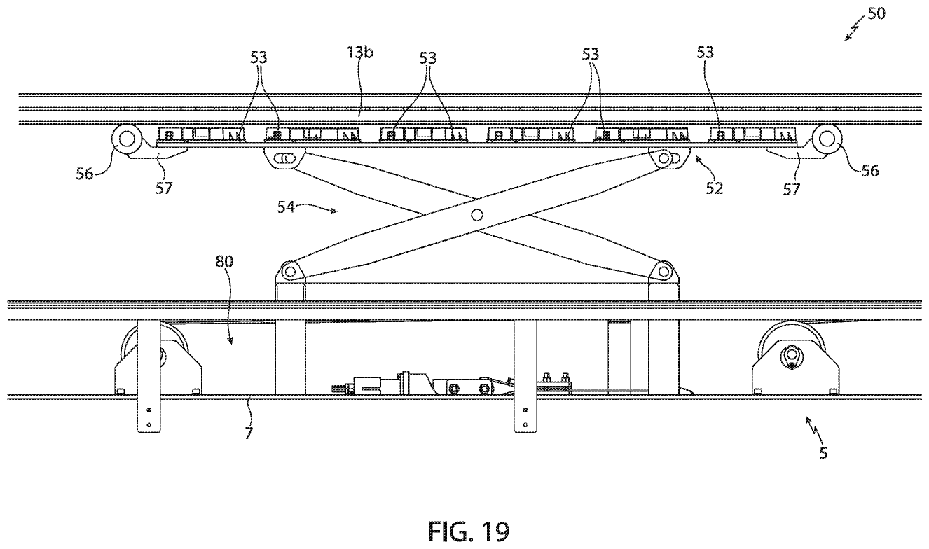

With reference to FIGS. 13 to 19, a first essential detail for the optimal and reliable operation of each module 5 is to choose a suitable embodiment of the second motorized system 21.

FIG. 13 schematically shows a highly preferred embodiment of such a motorized system 21.

According to this aspect of the invention, the three-dimensional supporting structure 7 (see FIGS. 1, 5a and 5b) is provided with four vertical legs 70, marked with references 70b, 70c, 70d, 70e: the pair of legs 70b, 70d define a first open flank 14 of the three-dimensional supporting structure 7, while the pair of legs 70c, 70e define the opposite open flank 14 thereof; similarly, the pair of legs 70b, 70c define the front end 11 of the supporting structure 7 and the pair of legs 70d, 70e define the rear end 12 thereof.

According to this preferred embodiment of the invention, each leg 70 terminates inferiorly with an identical foot 22, and each foot 22 is provided with/carries a motorized system 21 like the one shown in detail in FIG. 13.

The motorized system 21 of each leg 70 comprises firstly a pair of identical wheels 21b, mounted side by side on a single common axis of rotation. This axis of rotation is motorized, being rotatable in both possible clockwise and counterclockwise directions, by means of a motor 71 arranged coaxial with the pair of wheels 21b.

The motors 71 of the four legs 70 are actuated by the control system 23 synchronously, to advance or retreat the respective module 5 along the trajectory T.

According to a specific innovative solution of the invention, in order to allow the other described movements to each module 5, the pair of wheels 21b of each motorized system 21 is carried inferiorly, with the relative motor 71, by a plate or flange 72, which is constrained idle to the corresponding foot 22, whereby it can rotate in axis on the respective leg 70, perpendicularly to the axis of rotation of the motor 71. To the flange 72 there are constrained, for example laterally cantilevered, two opposite motors 73 arranged with a vertical axis, therefore parallel to the axis of rotation of the flange 72.

The two motors 73, preferably electric, each rotatably actuate a respective toothed pinion 74, which meshes with a stationary toothed wheel 75 carried integral by the corresponding foot 22. In this way a planetary transmission system is obtained, which also functions as a reducer, and which allows the flange 72 to rotate in a precise way and therefore the wheels 21b to be steered in a precise and controlled way.

According to a possible variant, instead of two identical motors 73 a single motor could be installed on the plate 72. However, it has been found that such a solution on the one hand necessarily entails a more powerful motor and therefore of larger dimensions, creating considerable bulbky problems and, on the other hand, it can create asymmetrically distributed stresses, which could be detrimental to a structure such as 7, destined to move loaded with a not insignificant weight.

With reference to FIG. 14, both in order to protect each motorized system 21, and in order to avoid obstacles optionally present on the floor 6, each foot 22 of each leg 70 is provided with a screen 76 which is cup-shaped, for example of cylindrical shape, which can be created both with a continuous and solid side wall 77, and with a mesh or grid side wall 78, according to the variant schematically shown on part of FIG. 14. Obviously, the two embodiments could be integrated, preceding a solid side wall 77, but equipped with windows closed by grids.

The side wall 77 can also be coated with a (known) sensorized fabric sensitive to contact or, preferably, the screen 76, however made, is provided with one or more contact or proximity sensor rings 79, particularly a sensor ring 79 is arranged at the lower edge of the cup-like screen 76, close to the floor 6.

According to a preferred embodiment (FIG. 5a), the three-dimensional supporting structure 7 can be made so as to be easily dismountable for transport from the place of production to that of use. To this end, it can be divided into an upper reticular frame 80, made as a single self-supporting and rigid piece, by means of welded or bolted metal beams, and into four side members 700 constrained integral, but in a removable manner, to the frame 80 by means of pairs of bolted plates 701. In this case, the feet 22 are carried integral and inferiorly by the side members 700, on the side opposite to the plates 701, and the previously described legs 70 are each formed by a side member 700, by a pair of bolted plates 701, and by an angular upright 702 forming an integral part of the frame 80 and obtained in piece therewith.

In this way, the frame 80 equipped with all the necessary electrical and mechanical devices, can be created as a stand-alone and standard element, which can be produced in series and easily packable, given the reduced height, while standard side members 700 of different lengths can be provided, to allow to obtain plants 1 of different heights, depending on the needs.

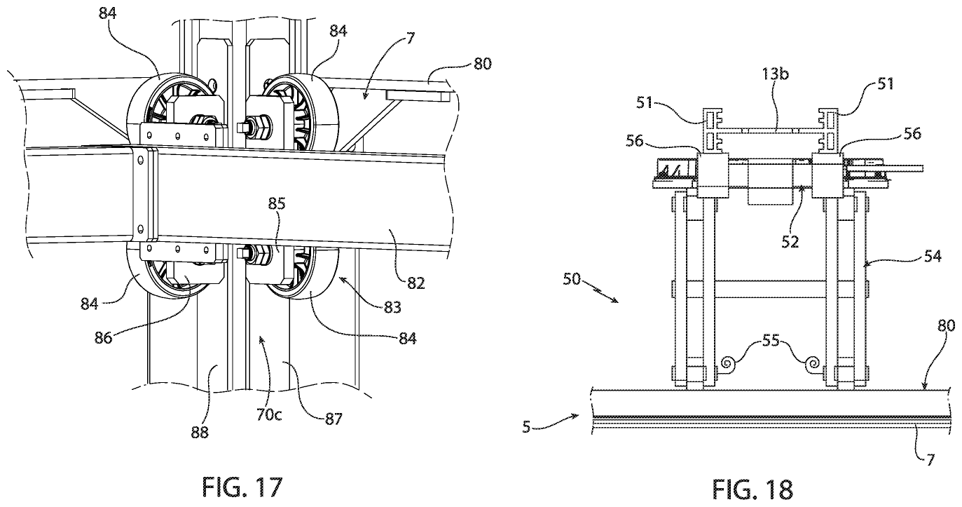

With reference to FIG. 17, according to a highly preferred embodiment of the invention, the hook unit 8 is not carried movably directly by the three-dimensional supporting structure 7, but is carried integral by a rigid frame 82, clearly visible in FIGS. 1 and 5a, 5b. The rigid frame 82, substantially rectangular in shape, slidably engages the four legs 70 and is guided by them in a vertical direction, both upwards and downwards, by means of corresponding skids 83.

Each skid 83, which is shown only schematically and without details in FIGS. 1 and 5a, b, is shown in the constructive detail only in FIG. 17.

According to one aspect of the invention, each skid 83 comprises two pairs of wheels 84, the wheels 84 of each pair being arranged in tandem, in vertical direction, at least partly one above and one below the rigid frame 82. A first pair of wheels 84 is carried by a plate 85, while a second pair of wheels 84 is carried by a plate 86. The two plates 85 and 86 are fixed integral, preferably bolted, to an angle of the frame 82 located, in the example shown, at the leg 70c; the plates 85 and 86 are arranged substantially at right angles to each other, so that the first and second pairs of wheels 84 couple in contact with opposite lateral faces 87, 88 of the leg 70c both facing towards the inside of the three-dimensional supporting structure 7.

In this way, the frame 82 is provided with pairs of wheels 84 arranged at right angles at each leg 70, which greatly improves the stabilization of the hook unit 8 and of its ends 15,16, which are shaped as rectilinear arms extending downwards parallel to the legs 70.

A stabilization against undesired movements (oscillating and the like) can be obtained by using even only a single wheel 84 for each plate 85, 86, also in any case arranged at an angle of 90° at each leg 70 and cooperating with the faces 87, 88, also arranged at right angles to each other. However, it was found that the obtainable stabilization is less effective than using pairs of wheels 84 arranged in tandem in the vertical direction, which configuration achieves maximum effectiveness.

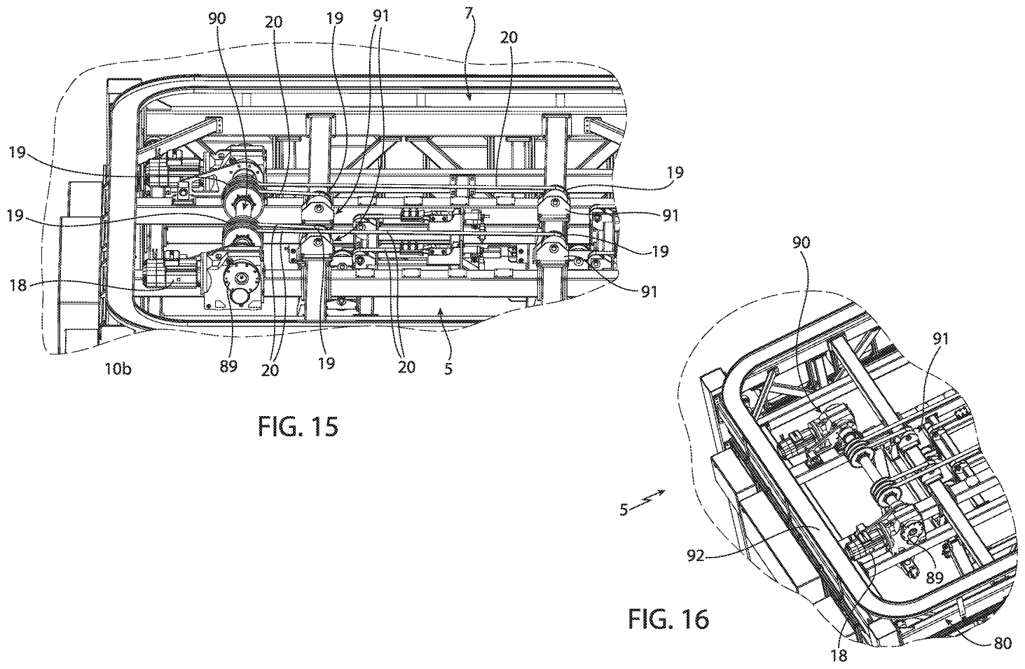

With reference to FIGS. 15 and 16, which shows on an enlarged scale an upper portion of a module 5, the upward/downward actuation of the frame 82 can also be carried out with a single motor 18: in this case, the motor 18 is arranged parallel to the flanks 14 and actuates a return box 89 which in turn actuates a drive shaft 90 arranged at 90° with respect to the axis of rotation of the motor 18. From this, the motion is transferred synchronously by means of the belts (or other flexible transmission elements) 20 and the pulleys 19 to elevators 91, with belt or rope, connected to opposite ends (in a known manner and not shown for simplicity's sake) of the frame 82 corresponding to the ends 15,16 of the hook unit 8. This means that the ends 15, 16 are raised or lowered simultaneously and to the same extent.

In order to be able to carry out, if necessary, the rotation and “pitching” movements (raising of one end 15 and simultaneous lowering of the end 16, and vice versa) of the hook unit 8, this can be mounted on the frame 82 not in a rigid manner, but by means of motorized systems also carried by the frame 82, which allow such movements thereof with respect to the frame 82. Such motorized systems are not described in detail as they are obvious to the skilled person on the basis of what has been described so far.

With reference to FIG. 16, on the upper face of the frame 80 it can be fixed, perimetrically thereto a duct or busbar 92, to accommodate all the electrical cables and relative accessories for the power supply of the various motors/actuators. This duct 92 could be superfluous if the reticular structure of the frame 80 provides in the upper part perimeter beams of the “double T” type (I″-shaped) which therefore have an upper empty space arranged perimetrically that acts as a container for the cables, instead of the duct 92.

Finally, with reference to FIGS. 18 and 19, 50 denotes as a whole a power supply system for the modules 5, operatively associated with a rail 13b, which is well shown in detail in FIG. 18, where, according to a preferred embodiment, it is arranged horizontally; therefore, with its respective wings 51 oriented in a vertical direction, while in the embodiment of FIG. 5b the I-shaped rail 13 is arranged vertically.

In particular, while the rail 13 is suitable for a sliding electric transmission, like a tram or electric traction units of trains, the rail 13b is configured as an induction busbar.

The power supply system 50 serves to electrically power the motorized systems 10 and 21 and any other accessories or electrical equipment on board each module 5, such as for example the control system 23b, totally or only as an integration of an on-board autonomous power supply, for example obtained by batteries, recharging the same.

According to a highly preferred embodiment of the invention, the rail or induction busbar 13b, which is not part of the power supply system 50 of a single module 5, being part of the plant 1, but is operatively associated with them, comprises a skid 52 operatively associated with the busbar 13b and provided on board with a plurality of coils (or flat windings or pads) 53 configured for the transfer of electrical energy by induction and facing the busbar 13b.

The skid 52 is supported by a pantograph elevator 54 provided with springs 55 (shown only schematically in FIG. 18), for example helical springs mounted coaxial to respective lower rotation pins 56 of the elevator 54 supported by the frame 80, so that the elevator 54 is constantly pushed towards a position of maximum extension in height and against the busbar 13b.

Of course, the springs 55 can be replaced by any other suitable thrust system (e.g. pneumatic or hydraulic) adapted to push the elevator 54 into the position of maximum elevation.

The transfer of energy from the busbar 13b to the coils or windings 53 takes place by electromagnetic induction and, therefore, without contact. However, it is of the utmost importance that the distance or gap present along the entire trajectory T between them and the busbar 13b is maintained constant.

For this purpose, the pantograph elevator 54 is used in combination with pairs of idle rollers 56 carried integral by the skid 52 on the opposite flanks thereof, arranged parallel to the flanks 14 of the corresponding module 5. In this way, the elevator 54 loaded by the springs 55, pushes the skid 52 against the busbar 13b, but in contact therewith, particularly with its opposite wings 51, the idle rollers 56 go, which can thus roll with low friction on the busbar 13b, and which protrude vertically and towards the busbar 13b beyond the lying plane of the coils 53, which are thus all maintained at a constant and small distance at will by the busbar 13b.

In the example shown, the rollers 56 are carried cantilevered by the skid 52, both vertically and horizontally, by means of arms 57, shaped like an open L with obtuse angle.

From the above it is clear that all the objects of the invention are therefore achieved.

1. A plant for carrying out the assembly of vehicles, the plant comprising a plurality of assembly stations configured to receive respective vehicle bodies and respective mechanical parts to be assembled on the vehicle bodies the plant comprising:
a plurality of mutually independent motorized modules, each module comprising:
a three-dimensional supporting structure equipped with a hook unit configured to receive a vehicle body and to hold the vehicle body constrained integral with the respective module;
a first motorized system mounted on the supporting structure and configured to at least raise and lower on command said hook unit; and
a second motorized system mounted on the supporting structure and configured to move each respective module horizontally;
a floor configured to receive said modules resting thereon, which modules are configured to move on said floor under the action of the second motorized system, so that the floor defines a ground plane of said plant; and
a control system to move each said module on said floor along a predetermined trajectory in a coordinated manner with the other modules, said control system being configured to define by means of said modules said assembly stations.

2. A plant according to claim 1, further comprising a plurality of motorized trolleys that are self-guided and configured to transport said mechanical parts, separately, or one or more per trolley, to predetermined modules, the trolleys being configured to go and flank a predetermined module either:
while the predetermined module is in motion, assuming the same speed; or
while the predetermined module was parked by the control system in a predetermined position on said floor.

3. A plant according to claim 1, characterized in that said control system is configured to move said modules on said floor sequentially, one behind the other but spaced apart to each other, arranged in a row line following in plan a trajectory that is rectilinear and/or curvilinear and/or serpentine-like, maintaining between the modules a constant or variable pitch; said modules being moved in a continuous or discrete manner, by successive steps interspersed with stops of predetermined duration.

4. A plant according to claim 3, wherein each module comprises a plurality of sensors (27), carried by each supporting structure, configured to provide the control system with the position and distance of at least one possible module preceding and one possible module following each module along said trajectory.

5. A plant according to claim 1, wherein said control system is at least partly on board each said module, constrained to said supporting structure, and is programmable, so that each supporting structure of each module constitutes a programmable self-driving vehicle.

6. A plant according to claim 1, wherein said control system is at least partially positioned stationary with respect to said floor and/or in the hands of an operator and communicates by means of a data transmission system, preferably of wifi type, with said modules.

7. A plant according to claim 1, wherein the first motorized system is configured not only to raise and lower on command said hook unit, but also to make the hook unit, and with it the hook unit the body carried by the hook unit, tilt toward a front end or rear end of the supporting structure by raising and/or lowering a corresponding end of the hook unit; and/or, to rotate the hook unit transversely to said front and rear ends of the supporting structure.

8. A plant according to claim 1, wherein the second motorized system is configured to advance and/or retreat the corresponding module on the side of the front or rear end of the supporting structure of the respective module; the supporting structure being provided with respective feet each provided with a pair of motorized wheels, with reversible rotation and identical to each other, mounted side by side on a single common axis of rotation; said pair of wheels of each motorized system being brought inferiorly, with a relative first motor, by a plate or flange constrained idle to the corresponding foot and to which they are laterally constrained cantilevered, two opposite motors arranged with vertical axis and parallel to the axis of rotation of the flange; said second motors rotatably actuating respective toothed pinions meshing with a stationary toothed wheel carried integral by the corresponding foot.

9. A plant according to claim 8, wherein the second motorized system is also configured to make the respective said modules move laterally, transversely to an ideal centreline connecting the front end and the rear end of the supporting structure with each other.

10. A method for carrying out the assembly of vehicles comprising the step of moving a respective body of a vehicle through a plurality of assembly stations to which are also fed respective mechanical parts to be assembled on the vehicle bodies, comprising the steps of:
making a plurality of independently movable modules, each of which comprises: a three-dimensional supporting structure equipped with a hook unit configured to receive a vehicle body and to hold the vehicle body constrained integral with the respective module; a first motorized system configured to at least raise and lower on command said hook unit; and a second motorized system configured to horizontally move each respective module;
moving each said module, with a vehicle body coupled to the hook unit, along a predetermined trajectory and in a coordinated manner with the other modules, so that each module reaches sequentially a plurality of predetermined positions along said trajectory, a same said module coming to constitute, sequentially, each of said assembly stations.

11. A method according to claim 10, further comprising the step of:
feeding said mechanical parts to said assembly stations by having each said module sequentially flanked by a self-guided trolley on which the mechanical parts to be assembled have been loaded; and/or hooking onto the supporting structure of each module at least some of the mechanical parts to be assembled.

12. A motorized module that can be associated with a plurality of other similar or identical motorized modules to create a plant for the assembly of vehicles which is totally movable and reconfigurable, said module comprising:
a three-dimensional supporting structure equipped with a hook unit configured to receive a vehicle body and to hold the vehicle body constrained integral with said module;
a first motorized system mounted on the supporting structure and configured to at least raise and lower on command said hook unit;
a second motorized system mounted on the supporting structure and configured to move the module horizontally on a support plane;
a control system carried on board by the supporting structure to move the module along a predetermined trajectory, in a coordinated manner with other modules similar or identical thereto, said control system being configured to cause the module to assume along said predetermined trajectory, a plurality of different positions in each of which the module comes to constitute sequentially, by time to time, a different assembly station of a plurality of assembly stations of the assembly plant;
said second motorized system comprising respective feet of the supporting structure each provided with a pair of motorized wheels, with reversible rotation and identical to each other, mounted side by side on a single common axis of rotation; said pair of wheels of each motorized system being brought inferiorly, with a relative first motor, by a plate or flange constrained idle to the corresponding foot and to which they are laterally constrained cantilevered, two opposite second motors arranged with vertical axis and parallel to the axis of rotation of the flange; said second motors rotatably actuating respective toothed pinions meshing with a stationary toothed wheel carried integral by the corresponding foot.

13. A motorized module according to claim 12, wherein each said foot is provided with a screen for protecting said wheels having a solid or grid side wall, or covered with a sensorized fabric, so that each screen is provided with at least one sensor, contact or proximity, at least at its lower edge.

14. A motorized module according to claim 12, wherein the supporting structure is divided into an upper reticular frame, made as a single self-supporting piece, and into four side members constrained integral, but removably, to the frame by means of pairs of bolted plates; said feet being carried integral and inferiorly by the side members, on the side opposite to the plates, each said side member forming, with a pair of said bolted plates and an angular upright forming an integral part of the frame a respective leg of said supporting structure.

15. A motorized module according to claim 12, wherein the hook unit is carried integral by a rigid frame, which slidably engages respective legs of the supporting structure to be guided by the latter in a vertical direction by means of corresponding skids; each skid comprising two pairs of wheels arranged in tandem in a vertical direction, at least in part one above and one below said rigid frame; a first pair of wheels being carried by a first plate, while a second pair of wheels being carried by a second plate; said plates being fixed arranged substantially at right angles to each other to couple the first and second pair of wheels in contact with lateral opposite faces of each leg both facing towards the inside of the three-dimensional supporting structure.

16. A motorized module according to claim 12, further comprising an electric power supply system operatively associable with an induction rail or busbar belonging to said plant for the assembly of vehicles, the electric power supply system comprising a skid operatively associable with the busbar and provided on board with a plurality of flat coils configured for the transfer of electric energy by induction, facing in use towards the busbar; a pantograph elevator constantly pushed towards a position of maximum extension in height; and pairs of idle rollers carried integral by the skid on opposite sides thereof, arranged parallel to respective sides of the module and configured to roll in use with low friction on the busbar, said idle rollers protruding vertically beyond the lying plane of the coils, preferably carried cantilevered by the skid, both vertically and horizontally, by means of arms, shaped like an open L with obtuse angle.

17. A motorized module according to claim 12, wherein the first motorized system is configured to at least one of tilt and rotate the hook unit.

18. A motorized module according to claim 12, wherein the support plane comprises a floor.

19. A plant according to claim 4, wherein the plurality of sensors comprises radar.

20. A plant according to claim 1, wherein the vehicle comprises a motor vehicle.
